(19) United States
(12) Patent Application Publication
(10) Pub. No.: US 2018/0298224 A1
(43) Pub. Date: Oct. 18, 2018

(54) PROCESS FOR PRODUCING CELLULOSE ESTER/ACRYLIC COMPOSITE LATEX PARTICLES

(71) Applicant: Eastman Chemical Company, Kingsport, TN (US)

(72) Inventors: Bradley James Helmer, Kingsport, TN (US); Junjia Liu, Kingsport, TN (US); Jennifer Lynn Cogar, Unicoi, TN (US); Casey Lynn Elkins, Kingsport, TN (US)

(73) Assignee: Eastman Chemical Company, Kingsport, TN (US)

(21) Appl. No.: 15/486,426

(22) Filed: Apr. 13, 2017

(51) Int. Cl. C09D 101/14; C08J 3/03; C09D 133/08; C08L 1/14; C08L 33/08

(52) U.S. Cl. CPC C09D 101/14; C08J 3/03; C09D 133/08; C08L 2201/54; C08L 33/08; C08J 2301/14; C08L 1/14

(57) ABSTRACT

The invention is a method for producing cellulose ester and acrylic composite latex particles and to latex compositions prepared from the method. The cellulose ester and acrylic composite materials are prepared by dispersing at least one cellulose ester in water and incrementally adding at least one acrylic monomer to said dispersion in the presence of a polymerization initiator. Surfactants and solvents are optionally added to aid in the dispersion of the cellulose ester in water.

### FIELD OF THE INVENTION

This invention pertains to latex particles and coating compositions containing latex particles. More particularly, this invention pertains to cellulose ester and acrylic composite latex particles and to a process for producing cellulose ester and acrylic composite latex particles.

### BACKGROUND OF THE INVENTION

The architectural coatings industry continues to look for ways to increase film hardness in ambient cure coatings without the use of volatile organic coalescing aids that enter the air during coating curing. Latex formulations form coatings by loss of water and coalescence of the polymer particles to form a cohesive film. To achieve such a film without the addition of a volatile coalescing aid, the latex polymer must be a soft, deformable polymer with a glass transition temperature (Tg) well below room temperature. The resulting soft coating can have deficiencies in hardness, block resistance, and dirt pick up. A separate hard polymer phase is sometimes incorporated in the latex particles to help overcome these deficiencies. One type of hard polymers are cellulose esters (CE). CE's have been incorporated in latex particles by a process sometimes referred to as “mini-emulsion polymerization”. The CE is dissolved in acrylic monomer and the resulting solution is dispersed in water with the use of surfactant and high shear force. This process has a number of limitations including the level of surfactant needed, the specialized equipment needed to create the high shear force, lack of flexibility in adjusting the ratio of acrylic/CE and the choice of various acrylic monomers, and difficulty in controlling the size and size distribution of the resulting particle.

A need exists for a cellulose ester/acrylic latex polymer for use in coatings applications that do not suffer from these limitations.

We have invented an improved process, whereby CE is first dispersed in water and the acrylic monomer is added gradually over time. The monomer migrates to the CE particle where it is quickly converted to acrylic polymer before substantial monomer can accumulate.

### SUMMARY OF THE INVENTION

According to an embodiment, the present disclosure concerns a method of polymerizing composite particles comprising:
(a) dispersing at least one cellulose ester in water;
(b) adding at least one acrylic monomer and a free radical polymerization initiator to the dispersion of step (a); and
(c) polymerizing said cellulose ester and acrylic monomer dispersion of step (b).

According to another embodiment of the invention, the present disclosure concerns a cellulose ester and acrylic composite material prepared by dispersing at least one cellulose ester in water and incrementally adding at least one acrylic monomer to said dispersion in the presence of a free-radical polymerization initiator to polymerize the resulting cellulose ester and acrylic composite material.

In yet another embodiment of the invention, the present disclosure concerns an aqueous latex coating composition comprising:
A.) 40 to 55 weight percent based on the weight of A and B of cellulose ester and acrylic copolymer particles, said particles prepared by dispersing (i) 2 to 40 weight percent based on the total weight of (i) and (ii) of at least one cellulose ester; in water and adding 60 to 98 weight percent based on the total weight of (i) and (ii), of (ii) at least one acrylic monomer to said dispersion in the presence of a free-radical polymerization initiator; and
B.) 45 to 60 weight percent water based on the total weight of A and B.

### DETAILED DESCRIPTION

Latex paints can have a number of issues, such as dirt pickup; low block resistance (a parameter that measures two painted surfaces' tendency to stick together when the surfaces are pressed against each other); and tackiness, a sticky feeling when warm hands are placed on a painted wall. One approach to reduce these issues is to increase the glass transition temperature (Tg) of the latex particles, by changing the compositions of the monomers during latex particle synthesis. Raising the glass transition temperature is also called raising the latex “hardness”. However, high-Tg latex particles do not tend to form a cohesive film by deforming and diffusing together. Extra coalescent can be added to lower the minimal film formation temperature (MFFT) of a high-Tg latex particle, but the organic coalescent materials may be subject to volatile organic compound (VOC) emission regulations.

Another way to improve the properties of soft latex films is to incorporate a small amount of a hard polymer into the latex particle. The present invention includes a latex particle comprising CE and acrylic polymer. The two polymers in latex are distinct phases, and chemical bonding or grafting between the two phases is not required. The present invention incorporates CE in latex, improving the hardness of the latex film while minimizing the increase in MFFT. This CE/acrylic composite particle is produced by first dispersing the CE in water then gradually adding acrylic monomer in the presence of a free-radical source to initiate the polymerization.

Unless otherwise indicated, all numbers expressing quantities of ingredients, properties such as molecular weight, reaction conditions, and so forth used in the specification and claims are to be understood as being modified in all instances by the term “about.” Unless indicated to the contrary, the numerical parameters set forth in the following specification and attached claims are approximations that may vary depending upon the desired properties sought to be obtained by the present invention. At the very least, each numerical parameter should be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in its respective testing measurements.

As used in the specification and the appended claims, the singular forms “a,” “an” and “the” include their plural referents unless the context clearly dictates otherwise. For example, a reference to a “polyester,” a “dicarboxylic acid”, a “residue” is synonymous with “at least one” or “one or more” polyesters, dicarboxylic acids, or residues and is thus intended to refer to both a single or plurality of polyesters, dicarboxylic acids, or residues. In addition, references to a composition containing or including “an” ingredient or “a” polyester is intended to include other ingredients or other polyesters, respectively, in addition to the one named. The terms “containing” or “including” are intended to be synonymous with the term “comprising”, meaning that at least the named compound, element, particle, or method step, etc., is present in the composition or article or method, but does not exclude the presence of other compounds, catalysts, materials, particles, method steps, etc., even if the other such compounds, material, particles, method steps, etc., have the same function as what is named, unless expressly excluded in the claims.

As used in the specification and the appended claims the term “incrementally” means one or more additions of a quantity of acrylic monomer and initiator (or other material) added to an aqueous dispersion of cellulose ester. Such incremental additions can be either separate additions added at time intervals or continuous, gradual amounts of acrylic monomer and initiator that are added over some period of time. For example, a discrete charge of “X” milliliters can be added to the dispersion at intervals spaced “Y” minutes apart or a continuous feed can be added to the dispersion at a rate of “Z” milliliters per minute.

Also, it is to be understood that the mention of one or more process steps does not preclude the presence of additional process steps before or after the combined recited steps or intervening process steps between those steps expressly identified. Moreover, the lettering of process steps or ingredients is a convenient means for identifying discrete activities or ingredients and the recited lettering can be arranged in any sequence, unless otherwise indicated.

The CE dispersion can be produced by any dispersion method known in the art, such as mixing in water in the presence of surfactant. To achieve a small particle-size dispersion, the CE must be in the liquid state, either as a melt or a solution in an appropriate solvent.

Suitable cellulose esters for use in this invention can be any CE known in the art. The cellulose esters of the present invention generally comprise repeating units of the structure:

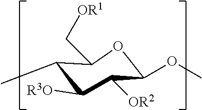

wherein R1, R2, and R3 are selected independently from the group consisting of hydrogen or straight chain alkanoyl having from 2 to 10 carbon atoms. For cellulose esters, the substitution level is usually express in terms of degree of substitution (DS), which is the average number of substituents per anhydroglucose unit (AGU). Generally, conventional cellulose contains three hydroxyl groups in each AGU unit that can be substituted; therefore, DS can have a value between zero and three. However, low molecular weight cellulose mixed esters can have a total degree of substitution ranged from about 3.08 to about 3.5. Native cellulose is a large polysaccharide with a degree of polymerization from 700-2,000, and thus the assumption that the maximum DS is 3.0 is approximately correct. However, as the degree of polymerization is lowered, as in low molecular weight cellulose mixed esters, the end groups of the polysaccharide backbone become relatively more significant, thereby resulting in a DS ranging from about 3.08 to about 3.5. Because DS is a statistical mean value, a value of 1 does not assure that every AGU has a single substituent. In some cases, there can be unsubstituted anhydroglucose units, some with two and some with three substituents, and more often than not the value will be a non-integer. Total DS is defined as the average number of all of substituents per anhydroglucose unit. The degree of substitution per AGU can also refer to a particular substituent, such as, for example, hydroxyl, acetyl, butyryl, or propionyl.

The cellulose ester utilized can be a cellulose triester or a secondary cellulose ester. Examples of cellulose triesters include, but are not limited to, cellulose triacetate, cellulose tripropionate, or cellulose tributyrate. Examples of secondary cellulose esters include cellulose acetate, cellulose acetate propionate, and cellulose acetate butyrate. These cellulose esters are described in U.S. Pat. Nos. 1,698,049; 1,683,347; 1,880,808; 1,880,560; 1,984,147, 2,129,052; and 3,617,201, incorporated herein by reference in their entirety to the extent that they do not contradict the statements herein.

In one embodiment of the invention, the cellulose esters have at least 2 anhydroglucose rings and typically have between 2 and 5,000 anhydroglucose rings. The number of anhydroglucose units per molecule is defined as the degree of polymerization (DP) of the cellulose ester. Cellulose esters typically have an inherent viscosity (IV) of about 0.2 to about 3.0 deciliters/gram or about 1 to about 1.5, as measured at a temperature of 25° C. for a 0.25 gram sample in 100 ml of a 60/40 by weight solution of phenol/tetrachloroethane. In another embodiment of the invention, the total degree of substitution per anhydroglucose unit (DS/AGU) of the cellulose esters useful herein can range from about 0.5 to about 2.8, from about 1.5 to about 3.0, and from about 1.7 to about 2.7. Examples of cellulose esters include, but are not limited to, cellulose acetate, cellulose propionate, cellulose butyrate, cellulose acetate propionate (CAP), cellulose acetate butyrate (CAB), cellulose propionate butyrate, and the like. Cellulose acetate useful herein typically has a DS/AGU for acetyl of about 2.0 to about 2.5. CAP and CAB typically have a total DS/AGU of about 1.7 to about 2.8.

Cellulose esters can be produced by any method known in the art. Examples of processes for producing cellulose esters are taught in Kirk-Othmer, Encyclopedia of Chemical Technology, 5th Edition, Vol. 5, Wiley-lnterscience, New York (2004), pp. 394-444. Cellulose, the starting material for producing cellulose esters, can be obtained in different grades and sources such as from cotton linters, softwood pulp, hardwood pulp, corn fiber and other agricultural sources, and bacterial cellulose, among others.

One method of producing cellulose esters is esterification of the cellulose by mixing cellulose with the appropriate organic acids, acid anhydrides, and catalysts. Cellulose is then converted to a cellulose triester. Ester hydrolysis is then performed by adding a water-acid mixture to the cellulose triester, which can then be filtered to remove any gel particles or fibers. Water is then added to the mixture to precipitate the cellulose ester. The cellulose ester can then be washed with water to remove reaction by- products followed by dewatering and drying.

The cellulose triesters to be hydrolyzed can have three substituents selected independently from alkanoyls having from 2 to 10 carbon atoms. Examples of cellulose triesters include cellulose triacetate, cellulose tripropionate, and cellulose tributyrate or mixed triesters of cellulose such as cellulose acetate propionate, and cellulose acetate butyrate. These cellulose esters can be prepared by a number of methods known to those skilled in the art. For example, cellulose esters can be prepared by heterogeneous acylation of cellulose in a mixture of carboxylic acid and anhydride in the presence of a catalyst such as H₂SO_{4.} Cellulose triesters can also be prepared by the homogeneous acylation of cellulose dissolved in an appropriate solvent such as Lithium Chloride/Dimethylacetamide (LiCl/DMAc) or Lithium Chloride/N-Methyl-2-pyrrolidone (LiCl/NMP).

Those skilled in the art will understand that the commercial term of cellulose triesters also encompasses cellulose esters that are not completely substituted with acyl groups. For example, cellulose triacetate commercially available from Eastman Chemical Company, Kingsport, Tenn., U.S.A., typically has a DS from about 2.85 to about 2.95.

After esterification of the cellulose to the triester, part of the acyl substituents are removed by hydrolysis or by alcoholysis to give a secondary cellulose ester. As noted previously, depending on the particular method employed, the distribution of the acyl substituents can be random or non-random. Secondary cellulose esters can also be prepared directly with no hydrolysis by using a limiting amount of acylating reagent. This process is particularly useful when the reaction is conducted in a solvent that will dissolve cellulose. All of these methods yield cellulose esters that are useful in this invention.

In one embodiment, the secondary cellulose esters useful in the present invention have a weight average molecular weight (Mw) from about 5,000 to about 400,000 as measured by GPC. In a further embodiment, the Mw is from about 10,000 to about 300,000. In yet further embodiments, the Mw ranges from about 10,000 to about 250,000; from about 10,000 to about 100,000, and from about 15,000 to about 80,000.

Secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a randomly secondary cellulose ester is obtained. That is, the relative degree of substitution (RDS) at each hydroxyl is roughly equal.

The cellulose esters described above can also contain ionizable groups. The ionizable groups can include sulfate half esters (as described in Philipp, B. et al., “Cellulose Sulphate Half-Ester. Synthesis, Structure and Properties,” Cellulose Chemistry and Technology, 1983, Volume 17, pages 443-459), tosyl urethanes (as described in U.S. Pat. No. 3,422,075), and preferably carboxylic acids. The carboxylic acid functionality can be provided by carboxyalkyl groups (as described in U.S. Pat. No. 5,668,273), by half esters of dicarboxylic acids (as described in U.S. Pat. No. 5,925,181), or preferably by oxidation of the CE (as described in U.S. Pat. No. 8,816,066).

In some embodiments, the CE can be dispersed in water without surfactants. CE's containing ionic functionality such as carboxylate, sulfate or sulfonate groups are particularly useful for forming surfactant-free dispersions. The CE can be cellulose acetate, cellulose propionate, cellulose butyrate, cellulose acetate butyrate, etc., including CE's modified to include ionic functionality (carboxylates, sulfates, sulfonates, etc.).

In one embodiment, this invention provides a waterborne latex particle compromising CE and acrylic polymer, which are joined without requiring chemical bonding or grafting.

The process for making the composite particles in the present invention is to feed CE dispersed as very small particles in water, with acrylic monomers, which transport through the water to the CE particles and polymerize there. Each original dispersed CE particle is converted to an acrylic/CE composite through this process.

In one embodiment of the invention the synthesis method can include (<2%) surfactants, free-radical initiators and neutralents, and is carried out at 50-100° C. over a period of 2-6 hours.

The polymerization process by which the polymers of this invention are polymerized may also require an initiator, a reducing agent, or a catalyst.

Suitable initiators include conventional initiators such as ammonium persulfate, hydrogen peroxide, t-butylhydroperoxide, sodium persulfate, potassium persulfate, di-benzoyl peroxide, lauryl peroxide, di-tertiarybutylperoxide, 2,2′-azobisisobuteronitrile, benzoyl peroxide, and the like.

Suitable reducing agents are those which increase the rate of polymerization and include, for example, sodium bisulfite, sodium hydrosulfite, sodium formaldehyde sulfoxylate, ascorbic acid, isoascorbic acid, and mixtures thereof.

Suitable catalysts are those compounds which promote activation of the polymerization initiator under the polymerization reaction conditions thereby increasing the rate of polymerization. Suitable catalysts include transition metal compounds and driers. Examples of such catalysts include, but are not limited to, ferrous sulfate heptahydrate, ferrous chloride, cupric sulfate, cupric chloride, cobalt acetate, cobaltous sulfate, and mixtures thereof.

Optionally, a conventional surfactant or a combination of surfactants may be used as a costabilizer or cosurfactant, such as an anionic or non-ionic emulsifier, in the suspension or emulsion polymerization preparation of a hybrid latex of the invention. In some embodiments of the invention surfactants include, but are not limited to, alkali or ammonium alkylsulfate, alkylsulfonic acid, or fatty acid, oxyethylated alkylphenol, or any combination of anionic or non-ionic surfactant.

The composite latex compositions are typically 2-40 wt % CE and 60-98 wt % acrylic polymer, or 1-40 wt % CE and 60-99 wt % acrylic polymer, or 0.5-40 wt % CE and 60-99.5 wt % acrylic polymer, or 0.1-40 wt % CE and 60-99.9 wt % acrylic polymer, or 2-30 wt % CE and 70-98 wt % acrylic polymer, or 1-30 wt % CE and 70-99 wt % acrylic polymer, or 0.5-30 wt % CE and 70-99.5 wt % acrylic polymer, or 0.1-30 wt % CE and 70-99.9 wt % acrylic polymer, or 2-20 wt % CE and 80-98 wt % acrylic polymer, or 1-20 wt % CE and 80-99 wt % acrylic polymer, or 0.5-20 wt % CE and 80-99.5 wt % acrylic polymer, or 0.1-20 wt % CE and 80-99.9 wt % acrylic polymer, or 2-15 wt % CE and 85-98 wt % acrylic polymer, or 1-15 wt % CE and 85-99 wt % acrylic polymer, or 0.5-15 wt % CE and 85-99.5 wt % acrylic polymer, or 0.1-15 wt % CE and 85-99.9 wt % acrylic polymer.

The acrylic monomers can be acrylate or methacrylate esters (ethyl acrylate, butyl acrylate, methyl acrylate, ethylhexyl acrylate, methyl methacrylate, butyl methacrylate, etc.), methacrylic acid, acrylic acid, styrene, or their combinations. Examples of suitable ethylenically unsaturated co-monomers include, but are not limited to, styrenic monomers such as styrene, a-methyl styrene, vinyl naphthalene, vinyl toluene, chloromethyl styrene and the like; ethylenically unsaturated species such as, for example, methyl acrylate, acrylic acid, methacrylic acid, methyl methacrylate, ethyl acrylate, ethyl methacrylate, butyl acrylate, butyl methacrylate, isobutyl acrylate, isobutyl methacrylate, ethylhexyl acrylate, ethylhexyl methacrylate, octyl acrylate, octyl methacrylate, glycidyl methacrylate, carbodiimide methacrylate, alkyl crotonates, vinyl acetate, di-n-butyl maleate, di-octylmaleate, and the like; and nitrogen containing monomers including t-butylaminoethyl methacrylate, dimethylaminoethyl methacrylate, diethylaminoethyl methacrylate, N,N-dimethylaminopropyl methacrylaniide, 2-t-butylaminoethyl methacrylate, N,Ndimethylaminoethyl acrylate, N-(2-methacryloyloxy-ethyl) ethylene urea, and ethacrylamidoethylethylene urea.

In one embodiment, the monomer is a combination of butyl acrylate (50-65 wt %), methacrylic acid (1-5 wt %), and either methyl methacrylate or styrene (27-43 wt %).

The CE composite latex of this invention can have a range of particle sizes of from about 50-400 nm. In another embodiment of the invention, the CE composite latex of this invention has a range of particle sizes from about 100-250 nm particles.

The latex can be neutralized to pH 7-9. The CE composite latex typically has 40-50 wt % solids in water. In one embodiment, the present invention provides a process of applying the above composite latex with minimal coalescent to a substrate to form a coating on the substrate. Coalescents can be used at levels from 0% to 20% on latex solids depending on the Tg of the bulk latex and can include a variety of esters, ester alcohols, and glycol ethers commonly used in latex paints. Some examples include TEXANOL™ ester alcohol and OPTIFILM™ 400 enhancer available from

Eastman Chemical Company.

### EXAMPLES

Although there are many ways to test film hardness, pendulum hardness and block resistance are two very common tests. An increase in pendulum hardness indicates that the surface of the material is harder. Block resistance is another measure of surface hardness. When the film is soft and tacky, the film will seal to itself.

The CE-composite latexes were compared to control latexes made without cellulose ester. Block resistance and pendulum hardness differences were also confirmed in a representative formulated paint system.

### Example 1

### Preparation of CE Dispersion

90 grams of cellulose acetate butyrate (CAB) SOLUS™ 3050 available from Eastman Chemical Company was dissolved in 250 grams of acetone in a plastic disposable jar using a high speed mixer with two blades. Dimethylamine (3.4 grams) was added with stirring. Water (470 grams) was then added over about 10 minutes. The resultant dispersion was filtered through 100 mesh screen. Defoaming agent (0.15 grams of FOAMASTER® NXZ available from BASF) was added to the dispersion. The dispersion was subjected to rotary evaporation with an ambient bath temperature to remove acetone. The dispersion was filtered through 325 mesh screen, giving cellulose ester dispersion Example 1.

### Example 2

### Synthesis of CE/Acrylic Composite Latex

To a 2000 mL resin kettle equipped with a condenser, nitrogen purge and subsurface feed tubes were added 500 grams of water, 13.3 grams of DOWFAX™ 2A1 surfactant (available from Dow Chemical Company), 3.3 grams ammonium persulfate initiator and 490 grams of a 17% solids dispersion of cellulose ester prepared in Example 1. A nitrogen purge was begun and the reactor heated to 85° C. and agitated at 250 rpm. A monomer mixture containing 285 grams of methyl methacrylate, 443 grams of butyl acrylate, and 22 grams of methacrylic acid was fed into the reactor incrementally over 3 hours. The reaction was held for an additional hour at 85° C. then cooled to room temperature. 1 mL of a 2% aqueous solution of ferric ammonium sulfate was added, followed by 1 mL 70% hydrogen peroxide, 10 mL of a 10% aqueous solution of sodium isoascorbate, and 125 grams of water. The latex was filtered through a 100 mesh metal screen and the pH was raised to 8.0 with 37 grams of 5% ammonium hydroxide. The final product had 42.8% solids and a particle size of 200 nm.

### Example 3

### Synthesis of CE/Acrylic Composite Latex

To a 2000 mL resin kettle equipped with a condenser, nitrogen purge and subsurface feed tubes were added 500 grams of water, 13.3 grams of DOWFAX™ 2A1 surfactant (available from Dow Chemical Company), 3.3 grams ammonium persulfate initiator and 245 grams of a 17% solids dispersion of cellulose ester prepared in Example 1. A nitrogen purge was begun and the reactor heated to 85° C. and agitated at 250 rpm. A monomer mixture containing 300 grams of methyl methacrylate, 467 grams of butyl acrylate, and 24 grams of methacrylic acid was fed into the reactor incrementally over 3 hours. The reaction was held for an additional hour at 85° C. then cooled to room temperature. 1 mL of a 2% aqueous solution of ferric ammonium sulfate was added, followed by 1 mL 70% hydrogen peroxide,10 mL of a 10% aqueous solution of sodium isoascorbate and 50 grams of water. The latex was filtered through a 100 mesh metal screen and the pH was raised to 8.0 with 34 grams of 5% ammonium hydroxide. The final product had 45.3% solids and a particle size of 200 nm.

### Example 4

### Synthesis of CE/Lower Tg Acrylic Composite Latex

To a 2000 mL resin kettle equipped with a condenser, nitrogen purge and subsurface feed tubes were added 500 grams of water, 13.3 grams of DOWFAX™ 2A1 surfactant (available from Dow Chemical Company), 3.3 grams ammonium persulfate initiator and 490 grams of a 17% solids dispersion of cellulose ester prepared in Example 1. A nitrogen purge was begun and the reactor heated to 85° C. and agitated at 250 rpm. A monomer mixture containing 225 grams of methyl methacrylate, 503 grams of butyl acrylate, and 22 grams of methacrylic acid was fed into the reactor incrementally over 3 hours. The reaction was held for an additional hour at 85° C. then cooled to room temperature. 1 mL of a 2% aqueous solution of ferric ammonium sulfate was added, followed by 1 mL 70% hydrogen peroxide, 10 mL of a 10% aqueous solution of sodium isoascorbate, and 50 grams of water. The latex was filtered through a 100 mesh metal screen and the pH was raised to 8.0 with 41 grams of 5% ammonium hydroxide. The final product had 44.6% solids and a particle size of 200 nm.

### Example 5

### Synthesis of CE/Styrene-Acrylic Composite Latex

To a 2000 mL resin kettle equipped with a condenser, nitrogen purge and subsurface feed tubes were added 500 grams (g) of water, 13.3 grams DOWFAX™ 2A1 surfactant, 3.3 grams ammonium persulfate initiator and 490 grams of a 17% solids dispersion of cellulose ester prepared in Example 1. A nitrogen purge was begun and the reactor heated to 85° C. and agitated at 250 rpm. A monomer mixture containing 263 grams styrene, 465 grams butyl acrylate, and 22 grams methacrylic acid was fed into the reactor over 3 hrs. The reaction was held for an additional hour at 85° C. then cooled to room temperature. 1 mL of a 2% aqueous solution of ferric ammonium sulfate was added, followed by 1 ml 70% hydrogen peroxide, 10 mL of a 10% aqueous solution of sodium isoascorbate, and 65 grams of water. The latex was filtered through a 100 mesh metal screen and the pH was raised to 8.0 with 51 grams of 5% ammonium hydroxide. The final product had 44.3% solids and a particle size of 191 nm.

### Comparative Example 6

### Synthesis of Acrylic Latex Control

To a 2000 mL resin kettle equipped with a condenser, nitrogen purge and subsurface feed tubes were added 900 grams of water, 13.3 grams DOWFAX™ surfactant, 3.3 grams ammonium persulfate initiator and 15 grams of a 20% solids 24 nm acrylic latex seed. A nitrogen purge was begun and the reactor heated to 85° C. and agitated at 250 rpm. A monomer mixture containing 342 grams methyl methacrylate, 531 grams butyl acrylate, and 27 grams methacrylic acid was fed into the reactor over 3 hrs. The reaction was held for an additional hour at 85° C. then cooled to room temperature. 1 mL of a 2% aqueous solution of ferric ammonium sulfate was added, followed by 1 ml 70% hydrogen peroxide and 10 mL of a 10% aqueous solution of sodium isoascorbate. The latex was filtered through a 100 mesh metal screen and the pH was raised to 8.0 with 16.1 grams of 10% ammonium hydroxide. The final product had 48.0% solids and a particle size of 186 nm.

### Comparative Example 7

### Synthesis of Styrene-Acrylic Latex Control

To a 2000 mL resin kettle equipped with a condenser, nitrogen purge and subsurface feed tubes were added 900 grams of water, 13.3 grams DOWFAX™ surfactant, 3.3 grams ammonium persulfate initiator and 15 grams of a 20% solids 24 nm acrylic latex seed. A nitrogen purge was begun and the reactor heated to 85° C. and agitated at 250 rpm. A monomer mixture containing 315 grams styrene, 558 grams butyl acrylate, and 27 grams methacrylic acid was fed into the reactor over 3 hrs. The reaction was held for an additional hour at 85° C. then cooled to room temperature. 1 mL of a 2% aqueous solution of ferric ammonium sulfate was added, followed by 1 ml 70% hydrogen peroxide, and 10 mL of a 10% aqueous solution of sodium isoascorbate. The latex was filtered through a 100 mesh metal screen and the pH was raised to 8.0 with 19 grams of 10% ammonium hydroxide. The final product had 48.5% solids and a particle size of 189 nm.

### Example 8

### Latex Film tests (MFFT, Pendulum Hardness, and Block Resistance)

Minimum film formation temperature (MFFT) of the latex was tested by ASTM D2354-10e1, block resistance of the clear film was tested by ASTM D4946, and pendulum hardness over time was tested by ASTM D4366. MFFT was tested at 6 mil film thickness. The film for pendulum hardness was prepared at 6 mil wet film thickness, and sample was tested at 1, 7, and 28 day dry time. The film for block resistance was prepared at 3 mil wet film thickness, and the sample was tested at 7, 14, and 28 day dry; the sample was placed in a 50° C. oven for 30 minutes, and then cooled to room temp for 30 minutes. The weight used for this clear latex film testing was 454 grams. Block resistance was evaluated based on the rating chart within the method. (Table 1)

MFFT of the composite latexes was typically slightly higher than the control latex, with an increase of approximately 2-4° C. Block resistance readings for composite latexes were substantially higher than the controls by ASTM ratings (the readings for the controls were typically 0-1). Pendulum hardness was also higher with the composite acrylic latexes.

TABLE 1
Latex Film Tests

| | | | Pendulum Hardness | | | Block Resistance | | |
|---|---|---|---|---|---|---|---|---|
| | Tg | MFFT | 24 | 7 | 28 | 7 | 14 | 28 |
| Example # | (° C.) | (° C.) | hour dry | day dry | day dry | day dry | day dry | day dry |
| Example 2 (CE/acrylic | 6.79 | 3.7 | 20 | 20 | 20 | 6 | 5 | 6 |
| composite latex) | | | | | | | | |
| Comparative Example 6 | 6.72 | 0.0 | 8 | 8 | 8 | 0 | 0 | 0 |
| (acrylic latex control) | | | | | | | | |
| Example 5 (CE/styrene- | 6.75 | 3.5 | 9 | 9 | 11 | 4 | 3 | 3 |
| acrylic composite latex) | | | | | | | | |
| Comparative Example 7 | 6.09 | 1.5 | 5 | 5 | 5 | 0 | 0 | 0 |
| (styrene-acrylic composite | | | | | | | | |
| control) | | | | | | | | |

### Example 9

### Film tests on formulated paint (Low Temperature Coalescence (LTC), Pendulum Hardness, and Block Resistance)

The paint formulation was a model formulation with a pigment volume concentration (PVC) of 35%, volume solids of approximately 42%, and weight solids of approximately 56%. Low temperature coalescence was tested by ASTM D7306-07 using the 10 mil wet film only and rated as outlined in the test method, block resistance was tested by ASTM D4946, and pendulum hardness over time was tested by ASTM D4366. The film for block resistance was prepared at 3 mil wet film thickness, and the sample was tested at 7, 14, and 28 day dry; the sample was placed in a 50° C. oven for 30 minutes, and then cooled to room temp for 30 minutes. Block resistance was evaluated based on the rating chart within the method. The film for pendulum hardness was prepared at 6 mil wet film thickness, and sample was tested at 1, 7, and 28 day dry time. (Table 2)

TABLE 2
Formulated Paint Film Tests

| | | Pendulum Hardness | | | Block Resistance | | |
|---|---|---|---|---|---|---|---|
| | LTC | 24 | 7 | 28 | 7 | 14 | 28 |
| Example # | @ 4° C. | hour dry | day dry | day dry | day dry | day dry | day dry |
| Paint formulated from Example 5 | 10 | 15 | 13 | 13 | 7 | 6 | 7 |
| (CE/styrene-acrylic composite latex) | | | | | | | |
| Paint formulated from Comparative | 10 | 12 | 10 | 10 | 0 | 0 | 0 |
| Example 7 (styrene-acrylic latex control) | | | | | | | |
| Paint formulated from Example 3 | 10 | 16 | 16 | 15 | 6 | 6 | 7 |
| (CE/acrylic composite latex) | | | | | | | |
| Paint formulated from Example 4 | 10 | 18 | 17 | 16 | 8 | 8 | 9 |
| (CE/lower Tg acrylic composite latex) | | | | | | | |
| Paint formulated from Comparative | 10 | 13 | 13 | 12 | 1 | 1 | 0 |
| Example 6 (acrylic latex control) | | | | | | | |

The pendulum hardness results show that incorporation of CE into the polymer increases the film hardness over the comparative examples. The tests also show that incorporation of the CE into the polymer significantly increases block resistance over the comparative examples.

The invention has been described in detail with particular reference to preferred embodiments thereof, but it will be understood that variations and modifications can be effected within the spirit and scope of the invention.

We claim:

1. A method of polymerizing composite particles comprising:
(a) dispersing at least one cellulose ester in water;
(b) adding at least one acrylic monomer and a polymerization initiator to the dispersion of step (a); and
(c) polymerizing said cellulose ester and acrylic monomer dispersion of step (b).

2. The method of claim 1 wherein said acrylic monomer is an acrylate, methacrylate, acrylate ester or methacrylate ester or a mixture thereof.

3. The method of claim 1 wherein said acrylic monomer is ethyl acrylate, butyl acrylate, methyl acrylate, ethylhexyl acrylate, methyl methacrylate, butyl methacrylate, methacrylic acid, acrylic acid, styrene, or mixtures thereof.

4. The method of claim 1 wherein said acrylic monomer is styrene, a-methyl styrene, vinyl naphthalene, vinyl toluene, chloromethyl styrene or mixtures thereof.

5. The method of claim 1 wherein said acrylic monomer is methyl acrylate, acrylic acid, methacrylic acid, methyl methacrylate, ethyl acrylate, ethyl methacrylate, butyl acrylate, butyl methacrylate, isobutyl acrylate, isobutyl methacrylate, ethylhexyl acrylate, ethylhexyl methacrylate, octyl acrylate, octyl methacrylate, glycidyl methacrylate, carbodiimide methacrylate, alkyl crotonates, vinyl acetate, di-n-butyl maleate, di-octylmaleate, or a mixture thereof.

6. The method of claim 1 wherein said acrylic monomer is t-butylaminoethyl methacrylate, dimethylaminoethyl methacrylate, diethylaminoethyl methacrylate, N,N-dimethylaminopropyl methacrylaniide, 2-t-butylaminoethyl methacrylate, N,Ndimethylaminoethyl acrylate, N-(2-methacryloyloxy-ethyl) ethylene urea, ethacrylamidoethylethylene urea or a mixture thereof.

7. The method of claim 1 wherein said cellulose ester is cellulose acetate, cellulose propionate, cellulose butyrate, cellulose acetate butyrate, cellulose triacetate, cellulose tripropionate, cellulose tributyrate cellulose acetate propionate, cellulose acetate butyrate and cellulose propionate butyrate or mixtures thereof.

8. The method of claim 7 wherein said cellulose ester is a cellulose ester modified with carboxylate, sulfanate or sulfonate functionality.

9. The method of claim 1 wherein said initiator is ammonium persulfate, ammonium carbonate, hydrogen peroxide, t-butylhydroperoxide, ammonium or alkali sulfate, di-benzoyl peroxide, lauryl peroxide, di-tertiarybutylperoxide, 2,2′-azobisisobuteronitrile, benzoyl peroxide or a mixture thereof.

10. The method of claim 1 further comprising adding at least one reducing agent to the dispersion of step (a).

11. The method of claim 10 wherein said reducing agent is sodium bisulfite, sodium hydrosulfite, sodium formaldehyde sulfoxylate, ascorbic acid, isoascorbic acid, or a mixture thereof.

12. The method of claim 1 further comprising adding at least one catalyst to the dispersion of step (a).

13. The method of claim 12 wherein said catalyst is ferrous sulfate heptahydrate, ferrous chloride, cupric sulfate, cupric chloride, cobalt acetate, cobaltous sulfate, or a mixture thereof.

14. The method of claim 1 wherein said acrylic monomer is a mixture of at least two of butyl acrylate, methacrylic acid, methyl methacrylate or styrene.

15. The method of claim 1 further comprising adding a surfactant to the dispersion of step (a).

16. The method of claim 1 wherein said surfactant is an alkyldiphenyloxide disulfonate.or polyoxyethylene alkylphenyl ether ammonium sulfate or a mixture thereof.

17. The method of claim 1 wherein the addition of acrylic monomer in step (b) is added incrementally over a time period of 0.5 to 4 hours.

18. A cellulose ester and acrylic composite material prepared by dispersing at least one cellulose ester in water and incrementally adding at least one acrylic monomer to said dispersion in the presence of a free-radical polymerization initiator.

19. A cellulose ester and acrylic composite latex particle comprising:
(a) an amount of 2 to 40 weight percent based on total solids, of at least one cellulose ester; and
(b) and amount 60 to 98 weight percent based on total solids, of at least one acrylic polymer; wherein said particle is prepared by dispersing said at least one cellulose ester in water and incrementally adding said at least one acrylic monomer to said dispersion in the presence of a free-radical polymerization initiator.

20. An aqueous latex coating composition comprising:
A.) 40-50 weight percent cellulose ester and acrylic copolymer particles prepared by dispersing 2 to 40 weight percent based on total solids of at least one cellulose ester; in water and incrementally adding 60 to 98 weight percent based on total solids, of at least one acrylic monomer to said dispersion in the presence of a free-radical polymerization initiator; and
B.) the balance to 100 weight percent water based on the total weight of A and B.

21. A method of polymerizing composite particles comprising:
(a) dissolving at least one cellulose ester in a volatile organic solvent;
(b) dispersing the cellulose ester/solvent blend of step (a) in water;
(c) removing said volatile organic solvent;
(d) adding at least one acrylic monomer and a polymerization initiator to the dispersion of step (c); and
(e) polymerizing said cellulose ester and acrylic monomer dispersion of step (d).
